(19) United States
(12) Patent Application Publication
(10) Pub. No.: US 2015/0134821 A1
(43) Pub. Date: May 14, 2015

(54) COMMUNICATION CONTROL SERVER, SERVICE PROVIDING SYSTEM, AND SERVICE PROVIDING METHOD

(71) Applicant: SEIKO EPSON CORPORATION, Tokyo (JP)

(72) Inventor: Hideaki OGATA, Yokohama (JP)

(21) Appl. No.: 14/495,193

(22) Filed: Sep. 24, 2014

(30) Foreign Application Priority Data
Nov. 11, 2013 (JP) 2013-232790

(51) Int. Cl. H04L 12/24; H04L 29/08

(52) U.S. Cl. CPC H04L 41/0893; H04L 67/14
USPC 709/225

(57) ABSTRACT

A communication control server includes an information holding part and a communication control part. The information holding part is configured to hold terminal registration information regulating groups built for a plurality of services, respectively, which are provided within the communication network by a plurality of service providing servers, and the terminal registration information associates the groups with information of terminals which belong to the groups. The communication control part is configured to relay communication between the terminals and communication between the terminals and the service providing servers, and further configured to permit communication between the terminals belonging to a common group and communication between the terminals and the service providing servers belonging to the common group, and prohibit communication between the terminals belonging to different groups and communication between the terminals and the service providing servers belonging to the different groups, by referring to the terminal registration information.

### CROSS-REFERENCE TO RELATED APPLICATIONS

This application claims priority to Japanese Patent Application No. 2013-232790 filed on Nov. 11, 2013. The entire disclosure of Japanese Patent Application No. 2013-232790 is hereby incorporated herein by reference.

### BACKGROUND

1. Technical Field

The present invention relates to a communication control server, a service providing system, and service providing method.

2. Related Art

One LAN (Local Area Network) is built among a plurality of terminals by connecting and making the plurality of terminals communicable in order to realize a certain work or a service. Also, corresponding to L3 address of L3 packet which is input, a network relaying device (L3 switch) to determine VLAN (virtual LAN) of a transmission destination has been well known (please see Japanese Laid Open Publication No. 2006-128803).

There is a chance that a user of a terminal belonging to a certain LAN thinks wanting to belong to a different LAN at the same time. In this case, a configuration such as one in FIG. 6 is necessary. In FIG. 6, switching hubs (SWHUB) 2, 3, 4, . . . are connected to a plurality of ports 1a, 1b, 1c . . . of which a L3 switch 1 includes. To each of SWHU 2, 3, 4, . . . , terminals 2a, 2b, . . . , terminal 3a, . . . , terminal 4a . . . are connected, and groups 5, 6, 7, . . . are formed, and each of the groups 5, 6, 7, . . . corresponding each LAN is formed for each of the SWHUB 2, 3, 4, . . . . With this configuration, the L3 switch 1 sorts L3 packet input from outside in order to correspond to the address for each of the group 5, 6, 7, . . . corresponding to the SWHUB 2, 3, 4, . . . . For this reason, for example, it is necessary for a user of the terminal 2b who would like to belong to both the groups 5 and 6 to use two network cards (LAN card) 2c1, 2c2 corresponding to each of the addresses for groups 5, 6 at the terminal 2b, and to connect the terminal 2b to the group 5 (SWHUB 2) and the group 6 (SWHUB 3) via the two network cards 2c1, 2c2 and two cables 2c3, 2c4.

Also, in a conventional configuration like this, physical restrictions are so strong. In other words, if the plurality of groups 5, 6 exist in a same building, it is possible to make the terminal 2b belong to each of the plurality of groups 5, 6 by handling a cable. However, if the plurality of groups 5, 6 exist in remote places to each other, it is impossible to connect the terminal 2b to the plurality of groups 5, 6 as show in FIG. 6.

### SUMMARY

The objectives of the present invention is to solve at least one of the problems mentioned above, and to provide the communication control server and the service providing system in order to release the user of the terminal from the physical restriction or a requirement regarding a hardware such as the network cards and the cable which are mentioned above, in order to make it easy for the terminal to belong each of the groups corresponding to each of the services via the Internet, and in order to guarantee security of the communication.

One arrangement of the invention is a communication control server which controls communication via a communication network including Internet, and includes an information holding part configured to hold terminal registration information regulating groups built for a plurality of services, respectively, which are provided within the communication network by a plurality of service providing servers, the terminal registration information associating the groups with terminals which belong to the groups, and a communication control part configured to relay communication between the terminals and communication between the terminals and the service providing servers. The communication control part is further configured to permit communication between the terminals belonging to a common group and communication between the terminals and the service providing servers belonging to the common group, and prohibit communication between the terminals belonging to different groups and communication between the terminals and the service providing servers belonging to the different groups, by referring to the terminal registration information.

With the configuration, of the terminal, relationship of belonging with group (one group or the plurality of the groups) which is built for each of the plurality of the services is administrated by the communication control server. Thus, the terminal is released from the physical restrictions regarding the above mentioned cable or the network card, as long as being connected to the Internet, and receives each of the services by the server for providing the service corresponding to each of the group to which the terminal belongs, and can communicate with another terminal belonging to each of the group. The group like this can be considered as an individual network for each of the groups which is virtually built in the Internet and include the server for the service corresponding to each of the groups and the terminal belonging to the group. Also, because the communication with the terminal which belongs to the different group and the communication with the server for providing the service corresponding to the group to which itself does not belong are prohibited, closed security in the group is guaranteed.

In one of the arrangements of the invention, the information holding part is configured to hold the terminal registration information by corresponding with the groups identification information which the service providing servers allot to the terminals which belong to the groups which the service providing servers correspond to. According to the configuration, the terminal can perform the communication with the server for providing the service and the communication with the terminal belonging to the same group, by using the identification information which the service providing server corresponding to the group to which itself belongs allocates.

In one arrangement of the invention, the communication control server further includes a change processing part configured to change corresponding relationship between the terminals and the groups which the terminal registration information regulates. The communication control part is further configured to relay the communication between the terminals and the communication between the terminals and the service providing servers by referring to the terminal registration information after being changed. According to the configuration, the corresponding relationship between the terminal and the group (one group or the plurality of groups) can be arbitrarily changed. In other words, it is possible to set freely by leaving from the physical restriction or the requirement regarding the network card or the cable as mentioned above.

A technological idea of the invention is not limited to the above mentioned communication control server, but other things, methods, or computer programs, as well as computer readable media, which are realized in various categories. Also, it is possible to recognize of a system of the invention including partially the communication control server, and an example of this includes a plurality of service providing servers configured to provide particular services within a communication network including the Internet, and a communication control server configured to control communication using the communication network. The service providing servers includes an identification information allotting part configured to allot identification information for identifying terminals to the terminals belonging to groups, the groups being built for the services to be provided, respectively. The communication control server includes an information holding part configured to hold terminal registration information regulating the groups which correspond to the plurality of service providing servers, the terminal registration information associating the groups with the identification information of the terminals belonging to the groups, and a communication control part configured to relay communication between the terminals and communication between the terminals and the service providing servers. The communication control part is further configured to permit communication between the terminals belonging to a common group and the communication between the terminals and the service providing servers belonging to the common group, and prohibit communication between the terminals belonging to different groups and communication between the terminals and the service providing servers belonging to the different groups, by referring to the terminal registration information.

### BRIEF DESCRIPTION OF THE DRAWINGS

Referring now to the attached drawings which form a part of this original disclosure:

FIG. 1 illustrates a figure schematically showing a system regarding the present embodiment;

FIG. 2 illustrates a block diagram showing functions to realize a service providing system;

FIG. 3 illustrates a figure which exemplifies a table equivalent to a terminal registration information;

FIG. 4 illustrates a flowchart showing a communication control process;

FIG. 5 illustrates a figure which exemplifies a table after being changed; and

FIG. 6 illustrates a figure showing a plurality of established LANs being conventional.

### DETAILED DESCRIPTION OF EXEMPLARY EMBODIMENTS

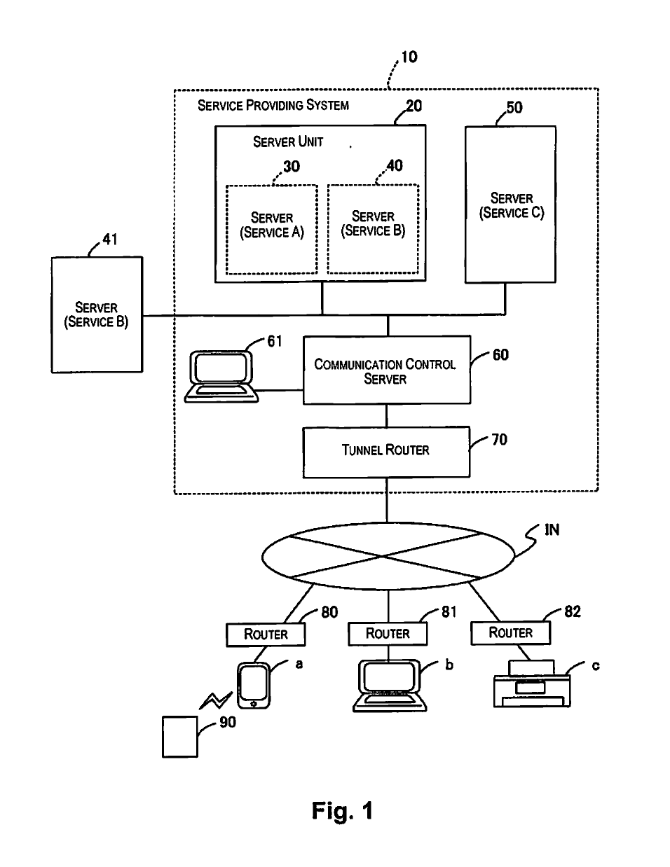

Hereinbelow, embodiments of the present invention are explained by referring to drawings. FIG. 1 exemplifies a simple overview of a system of the invention. Each configuration shown in FIG. 1 is connected to a communication network including Internet IN. The communication network is defined as the Internet IN or LAN (Ethernet (registered trademark)) connected to the Internet IN. In FIG. 1, a service providing system 10 includes a plurality of servers 30, 40, 50, . . . which are connected to a network, a communication control server 60, a tunnel router 70, and the like.

Each of the servers 30, 40, 50, . . . is a server for providing the service, and the each provides particular service by using the communication network including the Internet IN to the user. “Service” in the present specification can be free of charge or subject to fees. Also, providing to employees a network and information necessary for work of companies or the like is a kind of the service. For example, the server for providing the service functions only in providing to the employee (user) of a particular part of a company a network and information necessary for implementing work of the particular part. Hereinafter, for convenience, a service which a server 30 provides is a service A, a service which a server 40 provides is a service B, and a service which a server 50 provides is a service C.

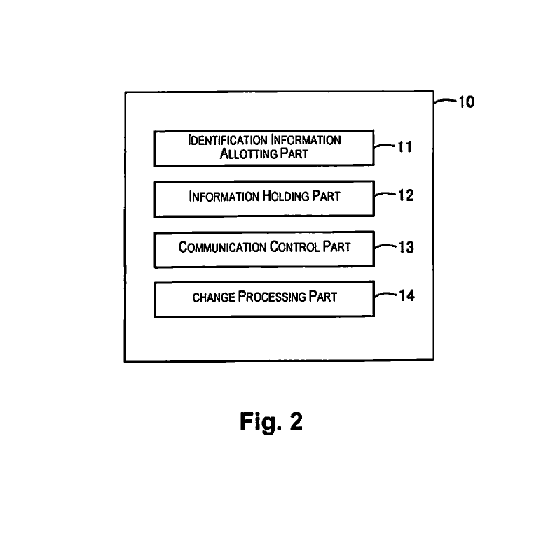

FIG. 2 is a block diagram showing functions (at least partially) that the service providing system 10 realizes. The service providing system 10 realizes various functions such as the identification information allotting part 11, the information holding part 12, the communication control part 13, and the change processing part 14. Of the functions, the identification information allotting part 11 is the function which the servers 30, 40, 50, . . . handle, while the information holding part 12, the communication control part 13, and the change processing part 14 are the function which the communication control server 60 handles. These functions are realized, at each server which handles, by commonly performing a computation process following a certain program with hardware resources such as a processor, a memory, and a hard disk.

The communication control server 60 holds each group built for each of the plurality of services (service A, B, C) and a terminal registration information (information holding part 12) which regulates information with the terminal (terminal that the user uses), and controls (relays) the communication between terminals and communication between the terminal and the servers 30, 40, 50, . . . , by referring to the terminal registration information (communication control part 13). The communication control server 60 is configured between the servers 30, 40, 50, . . . and a tunnel router 70. Hereinbelow, the group of the terminal which is built corresponding to one service is called a service group. Also, the group which corresponds to the service A is called service A group, the group which corresponds to the service B is called service B group, and the group which corresponds to the service C is called service C.

The service providing system 10 is connected to the Internet IN via the tunnel router 70. Also, the plurality of terminals (terminals a, b, c, . . . ) which the user uses is connected to the Internet IN via broadband routers (router 80, 81, 82, . . . ) configured at a home, an office, or the like. Needless to say, it is fine that the LAN is prepared for the plurality of terminals, which are connected to the plurality of the routers 80, 81, 82, . . . , for each of the routers 80, 81, 82, . . . . For example, smartphones, tablet type terminals, desk top type or lap top type personal computers (PC) or the like, printers, scanners, facsimile, and combined devices of these, various devices having network functions can be considered as the terminals a, b, c, . . . .

Each configuration in the service providing system 10 as shown in FIG. 1, each can be realized by a device which is physically independent, or at least part is realized logically by virtualizing the hardware resources in a device. The service 30 and service 40 shown in FIG. 1 as one example are established as the plurality of services to provide different services A, B by virtualizing the hardware resources in one device (server unit 20). In this meaning, the server 30 and the server 40 can be called VPS (virtual private server).

The server which provides the above mentioned service can exist outside the service providing system 10. For example, the service providing system 10 is connected to an external server 41 (FIG. 1). The server 41 has at least part of a necessary element (for example, an application software, or a data base) to realize the service B, and realizes provision of the service B by cooperating with the server 40 in the service providing system 10. In this case, the server 40 and the server 41 can be connected each other, for example, by a dedicated line, or the server 41 viewed from the server 40 can be connected as one of client terminals which belong to the service B group.

The identification information is assigned from the servers 30, 40, and 50 . . . to which the service group corresponds, as the terminals a, b, c, . . . belong to at least one of the service groups. In other words, each of the servers 30, 40, 50, . . . includes the identification information allotting part 11 which allots to the terminal belonging (demanding to belong) to the service group, that corresponds, the identification information identifying the terminal. Here, the identification information which is allotted is IP address (for example, IP v6 address). The allotting the IP address is realized by automatic allotting the IP address using DHCP (Dynamic Host Configuration Protocol) or by automatically allotting the IP address using RA (Router Advertisement). For example, in using the RA, the terminal a demanding to join the service A group receives a RA message from the server for providing the service A, and the IP address is allotted to the terminal a by automatically generating the IP address from the RA and a MAC address of itself. In case of the DHCP, the terminal a demanding to join the service A group, inquiry of the IP address necessary to join the service A group is transmitted by broadcasting. For this inquiry, each of the servers 30, 40, 50, . . . receives, the server 30 corresponding to the service A group of this replies to the terminal a, and the terminal a notifies candidates of the IP address which is usable. Thereafter, the server 30 allots to the terminal a one of IP address which has not been allotted at that time among the IP addresses in a settable range being determined beforehand by performing the communication between the server 30 and the terminal to follow the sequence of the DHCP. The terminal a sets to itself the IP address (for example 3000:0:0:1::10) being necessary to join the service A group being allotted like this.

Likewise, the IP address being necessary to join the service B group is allotted from the server 40 corresponding to the service B group to the terminal b which demands to join the service B group. Below, the terminal a has set the IP address (3000:0:0:1::10) being necessary for joining the service A group, the terminal b has set the IP address (3000:0:0:2::10) being necessary for joining the service B group and the IP address (3000:0:0:3::10) being necessary for joining the service C group, and the terminal c has set the IP address (3000:0:0:3::11) being necessary for joining the service C group. The communication control server 60 (information holding part 12) holds the terminal registration information by corresponding the identification information including the IP address with each of the service groups in the service providing system 10.

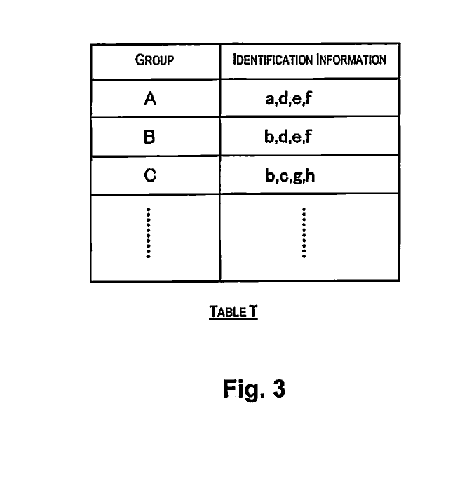

FIG. 3 exemplifies a table T corresponding to the terminal registration information. The table T records service group name (“A” representing the service A group, “B” representing the service B group, “C” representing the service group C), and the identification information corresponding (connected with a string) to each of the service groups. Here, in the example in the table T, the identification information “a” to which the service A group corresponds shows simply existence of the identification information. The identification information like this includes the IP address allotted to the terminal a from, as mentioned above, the server (the server 30 corresponding to the service A group which the terminal a demands to join) and other information, but it is shown as “a” in FIG. 3. “Other information” here is various information to specify uniquely the terminal, for example, a device unique ID or a serial number of the terminal a. The communication control server 60 extracts the identification information (IP address or other related information) regarding the terminal a like this from the communication for allotting the IP address between the terminal a and the server (server 30) corresponding to the service group to which the terminal a demands to join, and records on the table T.

Likewise, in the example of the table T, identification information “d”, “e”, “f” of terminals d, e, f (each not shown in FIG. 1) respectively is recorded as corresponding to the service A group. Also, in the example of the table T, the identification information “b”, “d”, “e”, “f” of the respective terminals b, d, e, f are recorded as corresponding to the service B group. Further, in the example of table T, the identification information “b”, “d”, “g”, “h” of the respective terminals b, c, g, f (terminals g, h are not shown in FIG. 1 like terminals d, e, f) are recorded as corresponding to the service C group. In other words, in the example of the table T, terminals a, d, e, f belong to the service A group, the terminals b, d, e, f belong to the service B group, the terminals b, c, g, h belong to the service C group. Also, some of the terminals belong to the plurality of service groups (terminal b belongs to the service B group and the service C group).

In the present embodiment, the communication of the tunnel router 70 of the service providing system 10 and each of the terminals a, b, c . . . via the internet IN is implemented by tunneling. Tunneling is a technology, by building a virtual path (tunnel) between two for communication, which makes the communication possible, although a network (for example, a network provided by a different internet service provider (ISP)) with an address system or a communication protocol between the two. VPN (Virtual Private Network) or IPsec (Security Architecture of Internet Protocol) is well known for the technology to build the tunnel. For example, when data (IP packet) are sent to a tunnel a from the server 30, the tunnel router 70, which is an entrance of the tunnel, recognizes IPv6 address of the server 30 as a transmission origin and adds a header which designates a global address (IPv4 address) of a router (router 80) of a recipient to a IP packet for which IPv6 address of the terminal is made as a transmission destination. And the IP packet following the head is sent to the router 80 via the Internet IN. When the IP packet is received, the router 80 transmits the IP packet without the header to the original transmission destination (IPv6 address of the transmission destination; namely terminal a). By the tunneling like this, the communication can be implemented by using IPv6 address via a network of IPv4 address system.

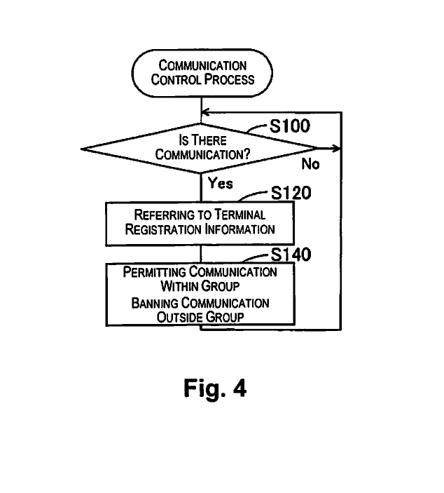

FIG. 4 shows a flowchart of a communication control process by the communication control part 13 of the communication control server 60. The communication control part 13 always monitors (steps S100) whether or not there is an input of the communication from servers 30, 40, 50 . . . which provides each service at the service providing system 10, and from each of the terminals a, b, c . . . . And when there is any input (“Yes” in step S100), it proceeds to step S120. In step S120, the communication control part 13 specifies, from the IP address or the like, the transmission origin of the communication and the transmission destination (access destination) by analyzing the communication input at step S100 most recently, and confirms whether or not the specified transmission origin of the communication and the transmission destination (access destination) belong to the same service group by referring to the terminal registration information (table T) which the information holding part 12 holds at that time.

In step S140, the communication control part 13 following the confirmation at step S120 most recently, passes (permits) the communication as is, when the communication is between the terminals belonging to the common service group, or the communication between the terminal and the server to which the service group to which the terminal belongs corresponds. On the other hand, when the communication is between the terminals belonging to the different service groups, or the communication is between the terminal and the server to which the service group to which the terminal does not belong corresponds, its communication is canceled (banned).

For example, following the examples in FIG. 1 and FIG. 3 (table T), the communication between the terminal a and the terminal b and the communication between the terminal a and the terminal c are canceled at step S140 because they are communication in the different service groups. On the other hand, the communication between the terminal b and the terminal c is permitted at step S140 because the communication is within the service C group. Also, the communication like this between the terminal b and the terminal c does not reach to the server 50 which is administrated by the service C group and can be a communication which is made by relaying the communication control server 60. Also, an access (and access of its opposite direction) from the terminal a to the server 30 which corresponds to the service A group, an access (and access of its opposite direction) from the terminal b to the server 40 which corresponds to the service B group, an access (and access of its opposite direction) from the terminal b to the server 50 which corresponds to the service C group, and access (and access of its opposite direction) from the terminal c to the server 50 which corresponds to the service C group are permitted at step S140.

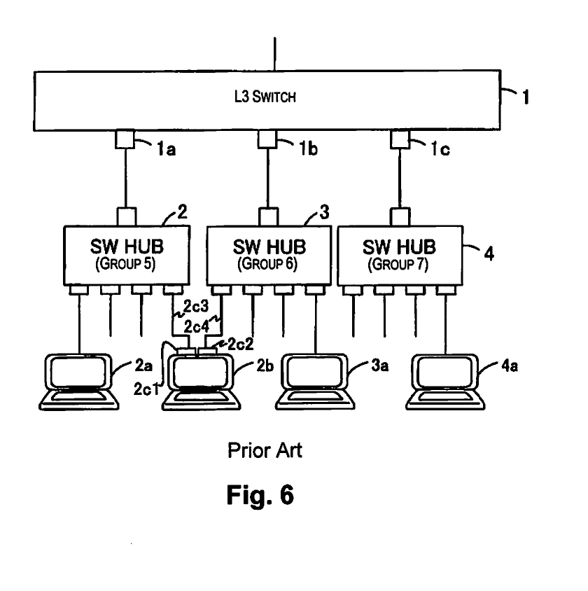

In other words, according to the present embodiment, regardless of a place at which the service providing system 10 is built and a place at which the terminals a, b, c, . . . exist, the communication control server 60 administrates the groups (service groups) for each of the services A, B, C, . . . , and guarantees the communication with in each of the service groups. Further, the communication control server 60 surely prevents information leakage to outside the service group by banning the communication across the service groups. The service group like this including a server for providing a service to which the service group corresponds builds a virtually individual network for each of the groups which does not have physical limitations such as distance. Also, according to the present embodiment, each of the terminals is easy to belong to the plurality of service groups in the service providing system 10, and is released, when compared with conventional arrangement (FIG. 6) in which the plurality of cables and network cards are necessary to belong to a different LAN, from the requirement which requires preparing a plurality of cables or network cards. For example, although it is the terminal b which belongs to the plurality of service groups as mentioned above, only one pair of the cables or the network cards are necessary for the terminal b to be connected to the service providing server 10 (to be connected to the router 81).

Also, within the individual network for each group as mentioned above, a communication is possible by one-to-many multicast. For example, the terminal a can transmits data simultaneously to the server 30 to which the service A group or to a different terminal which belongs to the service A group to which itself belongs. Also, the server 30 can notify updates of orders or information by push with regards to the service A to each of the terminals which belongs to the service A group to which itself belongs.

Also, as mentioned above, the communication between the terminal b and the terminal c is performed via the communication control server 60. For this reason, for example, when one (terminal b) is a PC including a printer driver, and the other (terminal c) is a printer which is driven and controlled by the printer driver, even if the both are physically remotely located, searching for the printer by the PC (printer driver), printing by the printer on the basis of an order from the PC (printer driver), acquiring status information from the printer by the PC (printer driver), notifying from the printer to the PC (printer driver), and the like can be performed in a way completely same as a PC and a printer which are located in LAN built locally.

Further for the present embodiment, the communication control server 60 includes a change processing part 14 which changes a corresponding relationship between the service group which the terminal registration information regulates and the terminal. The communication control server 60 is connected to a terminal 61 (FIG. 1). An operator of the terminal 61 conducts the operation to change the setting in the terminal registration information by using terminal 61, on the basis of a request or the like from an organization which operates the service providing system 10 or the requirement from each of the users of the terminals a, b, c, . . . . The change processing part 14 changes the corresponding relationship of the service group which the terminal registration information regulates and the terminal depending on the operation. The change processing part 14 deletes the identification information of a terminal (for example, the terminal b corresponding to the service C group) to which a service group from the terminal registration information, and records the identification information of the terminal b by corresponding the identification information of the terminal b to a different service group (for example, the service A group).

In the example of the change like this, at the time in which the identification information of the terminal b is recorded by corresponding to the service A group, the identification information of the terminal b does not includes the IP address allotted from the server 30 of the service A group. However, after the change is implemented, a new IP address for joining the service A group is allotted from the server 30, by the automatic allotting of the IP address by RA or DHCP to the terminal b. The new IP address allotted like this is over written in the identification information of the terminal b to which the service A group corresponds in the terminal registration information.

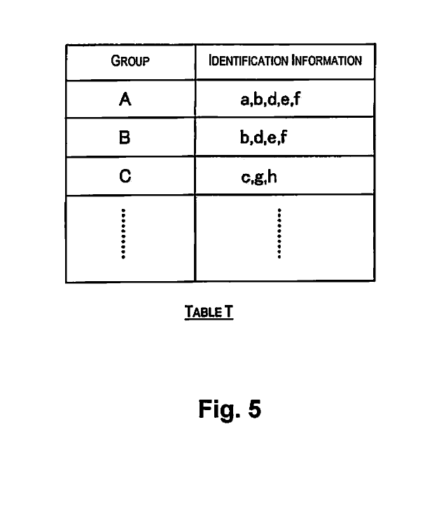

In FIG. 5, the terminal registration information (table T) after being changes is exemplified. According to FIG. 5, when compared with the table T shown in FIG. 3, the identification information “b” of the terminal b corresponding to the service C group is deleted, and the identification information “b” is newly recorded as corresponding to the service A group. Hereinafter, the communication control part 13 controls (relays) the communication which is mentioned above by referring to the terminal registration information after the change. As a result, the terminal b becomes unable to perform the communication with the terminal c or the like belonging to the service C group and the server 50, but can perform the communication with the terminal a belonging and the like to the service A group, or the server 30 According to the present embodiment like this, the operator can change the configuration (the relationship of each of the service groups and each of the users) of the virtually individual network for each group freely by operating the terminal 61.

Further, the present invention is not limited to the above mentioned embodiments, and can be implemented in various arrangements, as long as staying within its concept. For example, examples below are possible. Substance of combinations of the above mentioned embodiments and each example below is included in the disclosure of the present invention.

The terminal 90 as one example shown in FIG. 1 itself does not have network functions, but has close distance wireless communication (such as Bluetooth (registered trademark)) or Wi-Fi DIRECT (registered trademark). In this case, the terminal 90 can join the service providing system 10 via the Internet IN by using the terminals a, b, c, . . . , which have a networking function, as relaying devices. By this, the terminal 90 can received particular services by belonging to a service group, in the same way as the terminals a, b, c, . . . .

In the description above, a terminal which will belong to a service group receive IP address from a server corresponding to the service group. In other word, the IP address which is allotted from each of the servers 30, 40, 50, . . . to the terminal is allotted from different IP group (range of different IP address). However, the service providing system 10, for example, can allot unique IP address, which can be commonly used within the service providing system 10, to each of the terminals. For the example, after receiving the unique IP address for each of the terminals from either server (servers 30, 40, 50, . . . or the communication control server 60) of the service providing system 10, each of the terminals performs the communication with the service group to which it belongs at that time by using the IP address (regardless of whether or not changing to service group to which it belongs). Alternatively, for a different example, the service providing system 10 can allot one IP address of the IP group to each of the terminals which belongs to one or the plurality of the service groups, not all. Alternatively, for a different example, the service providing system 10 can allot IP address from a plurality of IP groups to each of the terminals which belongs one of the service groups.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A communication control server configured to control communication via a communication network including the Internet, the communication control server comprising:
an information holding part configured to hold terminal registration information regulating groups built for a plurality of services, respectively, which are provided within the communication network by a plurality of service providing servers, the terminal registration information associating the groups with terminals which belong to the groups; and
a communication control part configured to relay communication between the terminals and communication between the terminals and the service providing servers,
the communication control part being further configured to permit communication between the terminals belonging to a common group and communication between the terminals and the service providing servers belonging to the common group, and prohibit communication between the terminals belonging to different groups and communication between the terminals and the service providing servers belonging to the different groups, by referring to the terminal registration information.

2. The communication control server according to claim 1, wherein
the information holding part is configured to hold the terminal registration information by corresponding with the groups identification information which the service providing servers allot to the terminals which belong to the groups which the service providing servers correspond to.

3. The communication control server according to claim 1, further comprising
a change processing part configured to change corresponding relationship between the terminals and the groups which the terminal registration information regulates, wherein
the communication control part is further configured to relay the communication between the terminals and the communication between the terminals and the service providing servers by referring to the terminal registration information after being changed.

4. A service providing system, comprising:
a plurality of service providing servers configured to provide particular services within a communication network including the Internet; and
a communication control server configured to control communication via the communication network,
the service providing servers including an identification information allotting part configured to allot identification information for identifying terminals to the terminals belonging to groups, the groups being built for the services to be provided, respectively,
the communication control server including
an information holding part configured to hold terminal registration information regulating the groups which correspond to the plurality of service providing servers, the terminal registration information associating the groups with the identification information of the terminals belonging to the groups, and
a communication control part configured to relay communication between the terminals and communication between the terminals and the service providing servers,
the communication control part being further configured to permit communication between the terminals belonging to a common group and communication between the terminals and the service providing servers belonging to the common group, and prohibit communication between the terminals belonging to different groups and communication between the terminals and the service providing servers belonging to the different groups, by referring to the terminal registration information.

5. A service providing method in a service providing system including,
a plurality of service providing servers configured to provide particular services within a communication network including the Internet, and
a communication control server configured to control communication via the communication network;
the service providing method comprising:
allotting identification information for identifying terminals to the terminals belonging to groups, the groups being built for the services, respectively, which the service providing servers provide;
holding terminal registration information which regulates the groups which the plurality of service providing servers correspond to, the terminal registration information associating the groups with the identification information of the terminals which belong to the groups; and
relaying communication between the terminals and communication between the terminals and the service providing servers,
the relaying including permitting communication between the terminals belonging to a common group and communication between the terminals and the service providing servers belonging to the common group, and prohibiting communication between the terminals belonging to different groups and communication between the terminals and the service providing servers belonging to the different groups, by referring to the terminal registration information.
